(19) United States
(12) Patent Application Publication
(10) Pub. No.: US 2019/0286127 A1
(43) Pub. Date: Sep. 19, 2019

(54) VEHICLE CONTROL DEVICE

(71) Applicant: HONDA MOTOR CO., LTD., Tokyo (JP)

(72) Inventors: Takashi WATANABE, Wako-shi (JP); Kentaro ISHISAKA, Wako-shi (JP); Takafumi HIROSE, Wako-shi (JP); Takemi TSUKADA, Wako-shi (JP); Katsuya YASHIRO, Wako-shi (JP); Toru KOKAKI, Wako-shi (JP); Hisashi MATSUDA, Wako-shi (JP); Masaya IKEDA, Wako-shi (JP)

(21) Appl. No.: 16/281,848

(22) Filed: Feb. 21, 2019

(30) Foreign Application Priority Data
Mar. 14, 2018 (JP) 2018-047153

(51) Int. Cl. G05D 1/00; B60W 50/12

(52) U.S. Cl. CPC G05D 1/0061; B60W 50/12; G05D 2201/0213; B60W 2540/18; G05D 1/0088

(57) ABSTRACT

According to the present invention, a vehicle control device that carries out driving support or automated driving of a self-vehicle is provided. The vehicle control device comprises a steering controller that performs steering control on a manual operation by a driver or an automated operation. The steering controller accepts steering input by a manual operation by the driver in addition to a system steering amount by the vehicle control device while steering control by the vehicle control device is performed, returns a predetermined reaction force to the manual operation upon accepting the steering input, and makes the reaction force to the manual operation larger in a case where traveling is performed in a second state where steering wheel grasping is unrequired, as compared with a case where traveling is performed in a first state where steering wheel grasping is required.

### CROSS-REFERENCE TO RELATED APPLICATION(S)

This application claims priority to and the benefit of Japanese Patent Application No. 2018-047153 filed on Mar. 14, 2018, the entire disclosure of which is incorporated herein by reference.

### BACKGROUND OF THE INVENTION

### Field of the Invention

The present invention relates to a vehicle control device for performing automated driving and driving support of an automobile, for example.

### Description of the Related Art

In automated driving or driving support of vehicles including a four-wheel vehicle, a specific direction or all directions of the vehicle are monitored by sensors, the state of a driver and the traveling state of the vehicle are monitored, and in response to the monitoring results, automated driving of the vehicle on an appropriate route at an appropriate speed is controlled, or driving by the driver is supported. Even in a vehicle having the automated driving function like this, there is a demand for a driver to be involved mainly in driving, and such a situation and a state may occur. In the case like this, the driver can intervene in driving manually even during automated driving.

As the art for making the automated driving like this and manual driving by the driver compatible, there are proposed Japanese Patent Laid-Open No. 2017-218020 and the like. Japanese Patent Laid-Open No. 2017-218020 describes an art of switching a level of the automated driving control state of a vehicle to manual driving from automated driving based on the operating amount of the steering wheel, and setting a steering reaction force to steering corresponding to the level of the automated driving control state in response to a steering wheel grasping state of the driver.

However, in general, there are several levels in an automated driving control state, and an automation rate of automated driving, in other words, a load on the driver differs according to the levels. For example, at a level at which the driver load is low, there is a possibility that it takes a time for the driver to return his or her power of attention to the power of attention capable of manual driving, and it is desirable to continue stable automated driving by suppressing sensitive reactions to an operation of the driver, whereas at a level at which the driver load is high on the other hand, the driver is prepared for the manual driving, so that it is desirable to follow the intention of the driver.

### SUMMARY OF THE INVENTION

The present invention provides a vehicle control device that appropriately makes automated driving and manual driving by a driver who intervenes in automated driving compatible.

The present invention has the following configuration.

That is, according to one aspect of the present invention, the present invention provides a vehicle control device that carries out driving support or automated driving of a self-vehicle, including a steering controller that performs steering control on a manual operation by a driver or an automated operation by the vehicle control device, wherein the steering controller can accept steering input by a manual operation by the driver in addition to a system steering amount by the vehicle control device while steering control by the vehicle control device is performed, returns a predetermined reaction force to the manual operation upon accepting the steering input, and makes the reaction force to the manual operation larger in a case where traveling is performed in a second state where steering wheel grasping is not required, as compared with a case where traveling is performed in a first state where steering wheel grasping is required.

Alternatively, according to another aspect of the present invention, the present invention provides a vehicle control device that carries out driving support or automated driving of a self-vehicle, including a steering controller that performs steering control on a manual operation by a driver or an automated operation by the vehicle control device, wherein the steering controller can accept steering input by a manual operation by the driver in addition to a system steering amount by the vehicle control device while steering control by the vehicle control device is performed, returns a predetermined reaction force to the manual operation upon accepting the steering input, and makes the reaction force to the manual operation larger in a case where traveling is performed in a second state where surroundings monitoring is not required, as compared with a case where traveling is performed in a first state where surroundings monitoring is required.

According to the present invention, automated driving and manual driving by a driver who intervenes in the automated driving can be properly made compatible.

Further features of the present invention will become apparent from the following description of exemplary embodiments with reference to the attached drawings.

### BRIEF DESCRIPTION OF THE DRAWINGS

FIG. 1 is a diagram illustrating a configuration of a vehicle system of an automated driving vehicle of an embodiment;

FIG. 2 is a functional block diagram of a vehicle control system (control unit);

FIG. 3 is a block diagram of a steering device;

FIG. 4 is a state transition diagram illustrating transition of an automated driving level according to a first embodiment;

FIG. 5 is a diagram illustrating a reaction force characteristic of a steering wheel; and

FIGS. 6A and 6B are diagrams explaining control of keeping a traveling road by automated driving.

### DESCRIPTION OF THE EMBODIMENTS

### First Embodiment

Outline of Automated Driving and Travelling Support

First, an outline of an example of automated driving will be described. In automated driving, a driver generally sets a destination from a navigation system mounted on a vehicle and determines a route to the destination by a server or the navigation system, before traveling. When the vehicle is started, a vehicle control device (or a driving control device) configured by an ECU and the like of the vehicle drives the vehicle to the destination along the route. During that time, the vehicle control device determines an appropriate action at an appropriate time in response to elements in the external environment such as a route and a road situation, a state of the driver and the like, and causes the vehicle to travel by performing, for example, driving control, steering control, braking control and the like for the action. These kinds of control may be collectively called traveling control.

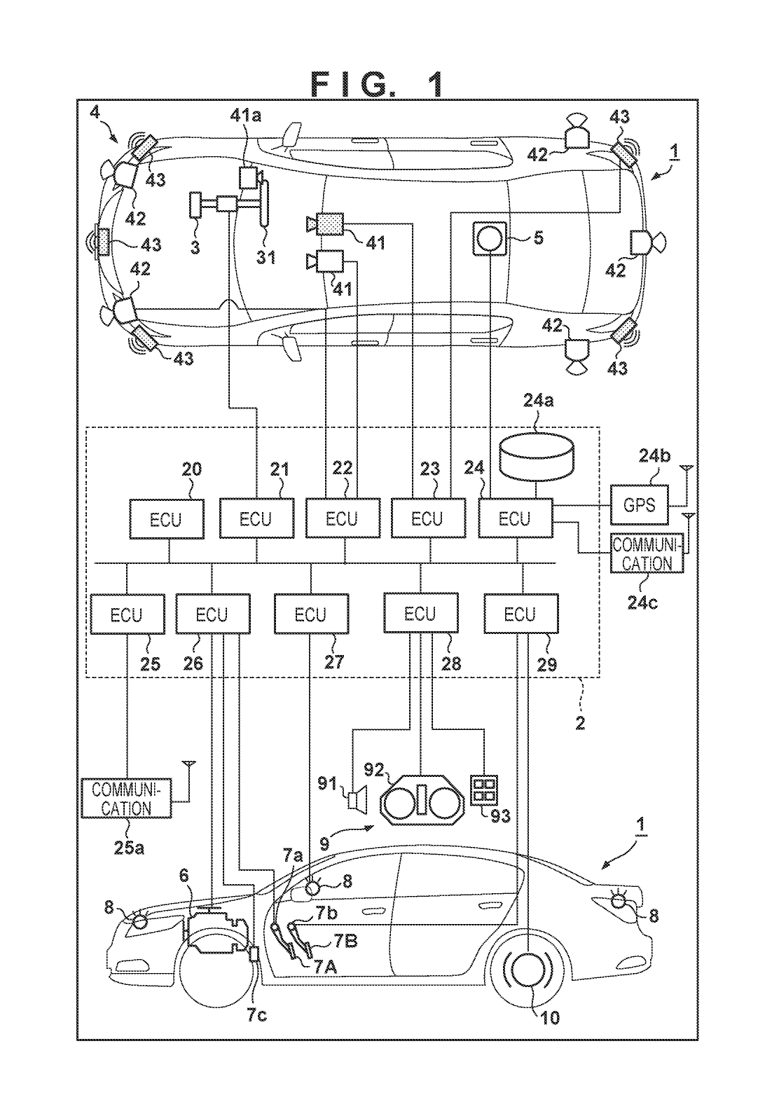

There are several control states (levels of the automated driving control state or simply called states) in automated driving depending on the automation rate (or an amount of task required of the driver). In general, as the level of the automated driving control state is higher, and accordingly the automation level is higher, the task (that is, a load) required of the driver is reduced more. For example, in the control state in the highest order (a third control state) in the present example, the driver may pay attention to things other than driving. This is performed in an environment which is not so complicated such as the case of following the car in front in the traffic jam on a highway, for example. Further, in a second control state of a lower order from the third control state, the driver does not have to hold the steering wheel, but needs to pay attention to a surrounding situation and the like. The second control state may be applied to a case of cruising on a highway or the like with few obstacles. It can be detected by a driver state detecting camera 41a (refer to FIG. 1) that the driver pays attention to surroundings, and it can be detected by a steering wheel grasping sensor that the driver grasps the steering wheel. With the driver state detecting camera 41a, a watching direction may be determined by recognizing pupils of the driver, and in a simpler way, a face is recognized, and a direction in which the face is directed may be estimated as the watching direction of the driver.

In a first control state at a lower order from the second control state, the driver does not have to perform a steering wheel operation or a throttle operation, but needs to hold the steering wheel to prepare for transfer (takeover) of driving control from the vehicle to the driver, and pay attention to a traveling environment. A 0^{th} control state at a further lower order from the first control state is manual driving, but includes automated driving support. A difference between the first control state and the 0^{th} control state is that the first control state is one of the control states of automated driving and can transition to the second and third control states under control by the vehicle 1 in response to the external environment, the traveling state, the driver state and the like, whereas in the 0^{th} control state, the control state remains in the 0^{th} control state as long as there is no switching instruction to the automated driving by the driver.

The driving support in the aforementioned 0^{th} control state is a function of supporting the driving operation by the driver who mainly drives by monitoring surroundings and partial automation. For example, the driving support includes LKAS (Lane Keeping Assist System) and ACC (Adaptive Cruise Control).

Further, there are an automated braking function of braking when monitoring only a front and detecting an obstacle, a rear monitoring function of detecting vehicles at an obliquely rear side and urging the driver to pay attention, a function of parking in a parking space and the like. All of the functions may be realized also in the first control state of automated driving. Note that LKAS is a function of keeping a lane by recognizing a white line or the like on a road, for example, and ACC is a function of tracking a vehicle traveling in front according to the speed of the vehicle.

Even during automated driving, the driver may intervene in the driving or perform a correction operation. This is called override. For example, when the driver performs a steering and an acceleration operation during automated driving, the driving operation by the driver may be prioritized. In this case, even when the driver stops the operations, the automated driving function is continuously working so as to be able to restart automated driving from a time point of stopping the operation. Accordingly, even during override, the automated driving control state can vary. Further, when the driver performs a braking operation, the automated driving may be cancelled to shift to the manual driving (the 0^{th} control state).

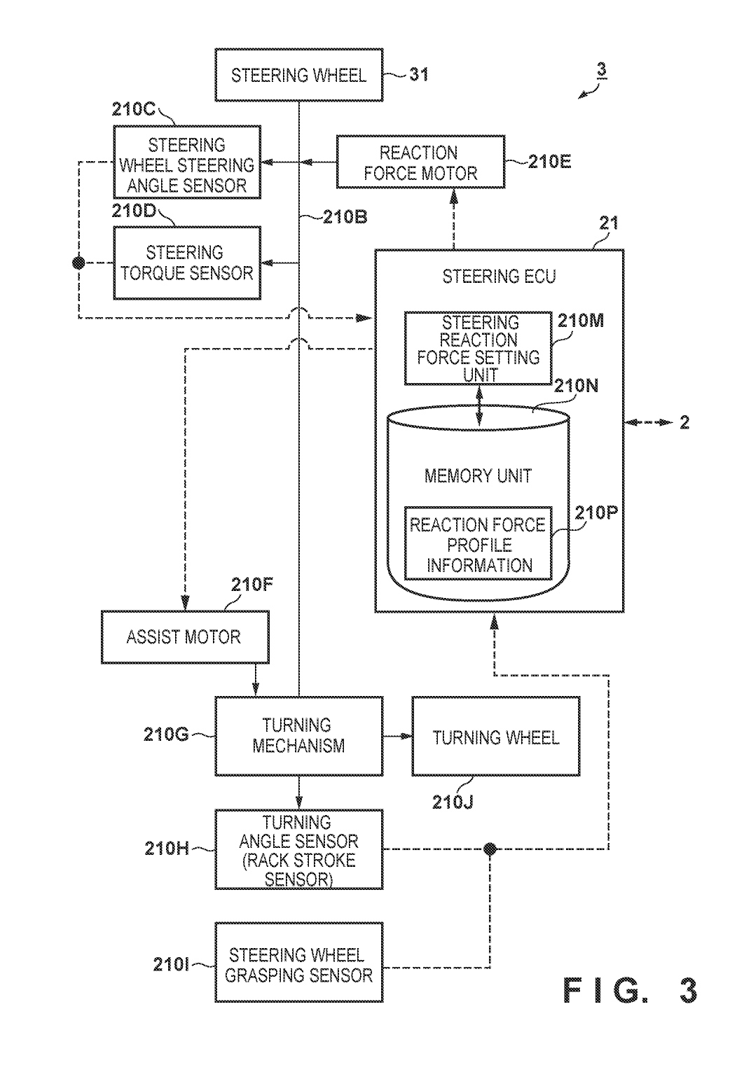

When the automated driving control state (or the automation level) is switched, the driver is notified of switching by the vehicle by sound, display, vibration or the like. For example, when automated driving is switched to the second control state from the first control state mentioned above, the driver is notified that the driver may release the steering wheel. In the opposite case, the driver is notified to grasp the steering wheel. The notice is repeatedly issued until it is detected that the driver grasps the steering wheel by a steering wheel grasping sensor (for example, a sensor 210I in FIG. 3). When the steering wheel is not grasped within a time limit, for example, or by a critical point of switching of the automated driving control state, an operation of stopping the vehicle in a safe place or the like may be performed. Although switching from the second control state to the third control state is the same, in the third control state, surrounding monitoring obligation of the driver is released, so that the driver is notified of a message of the surrounding monitoring obligation being released. In the opposite case, the driver is notified to monitor the surroundings. The notice is repeatedly issued until it is detected that the driver monitors surroundings by a driver state detecting camera 41a. Automated driving is performed substantially as described above, and a configuration and control for the automated driving will be described as follows.

Configuration of Vehicle Control Device

FIG. 1 is a block diagram of the vehicle control device according to one embodiment of the present invention, which controls a vehicle 1. In FIG. 1, an outline of the vehicle 1 is illustrated in a plan view and a side view. The vehicle 1 is a sedan type four-wheeled passenger car, as an example.

A control device in FIG. 1 includes a control unit 2. The control unit 2 includes a plurality of ECUs 20 to 29 that are communicably connected by an in-vehicle network. Each of the ECUs includes a processor represented by a CPU, a memory device such as a semiconductor memory, an interface with an external device and the like. In the memory device, a program executed by the processor, data that is used by the processor in processing and the like are stored. Each of the ECUs may include a plurality of processors, memory devices, interfaces and the like.

Hereinafter, functions and the like that are taken charge of by the respective ECUs 20 to 29 will be described. The number of ECUs, and functions taken charge of by the ECUs can be properly designed for the vehicle 1, and may be fractionized more, or integrated more than the present embodiment.

The ECU 20 executes control relating to automated driving of the vehicle 1. In the automated driving, at least either one of steering of the vehicle 1, and acceleration and deceleration is automatedly controlled. In a control example to be described later, both of steering, and acceleration and deceleration are automatedly controlled.

The ECU 21 is a steering ECU that controls a steering device 3. The steering device 3 includes a mechanism that steers front wheels in response to a driving operation (steering operation) of the driver to a steering wheel (also referred to a handle) 31. Further, the steering device 3 is an electric power steering device, and includes a motor that assists a steering operation or exhibits a driving force for automatically steering the front wheels, a sensor that detects a steering angle and the like. When the driving state of the vehicle 1 is automated driving, the ECU 21 automatedly controls the steering device 3 in response to an instruction from the ECU 20, and controls a traveling direction of the vehicle 1.

The ECUs 22 and 23 perform control of detection units 41 to 43 that detect a surrounding situation of the vehicle and information processing of a detection result. The surrounding situation is also called a surrounding state and an external environment, and information obtained by detecting them is called surrounding situation information, surrounding state information, external environment information or the like. The detection units for the surrounding state, and the ECUs that perform control of the detection units are collectively called a surrounding monitoring device, a surrounding monitoring unit or the like. The detection unit 41 is a camera that photographs a front of the vehicle 1 (hereinafter, sometimes described as a camera 41), and in the case of the present embodiment, two of the detection units 41 are provided in an interior of the vehicle 1. By analysis of an image photographed by the camera 41, a contour of a target can be extracted, and carriageway marking (white line and the like) of a lane on a road can be extracted. A detection unit 41a is a camera for detecting a state of the driver (hereinafter, sometimes described as a driver state detecting camera 41a), is installed to capture an expression of the driver, and is connected to an ECU that performs processing of the image data though not illustrated. Further, there is a steering wheel grasping sensor 210I, as a sensor for detecting a diver state. Thereby, it can be detected whether or not the driver grasps the steering wheel. The driver state detecting camera 41a and the steering wheel grasping sensor 210I are also collectively referred to as a driver state detecting unit.

The detection unit 42 is LIDAR (Light Detection and Ranging, or Laser Imaging Detection and Ranging) (hereinafter, sometimes described as the LIDAR 42), which detects a target around the vehicle 1, and measures a distance from the target. In the case of the present embodiment, five LIDARs 42 are provided, one for each corner portions of a front portion of the vehicle 1, one for a center of a rear portion, and one for each side of a rear portion. The detection unit 43 is a millimeter wave radar (hereinafter, sometimes described as the radar 43), which detects a target around the vehicle 1, and measures a distance from the target. In the case of the present embodiment, five radars 43 are provided, one for a center of the front portion of the vehicle 1, one for each corner portion of the front portion, and one for each corner portion of the rear portion.

The ECU 22 performs control of the one camera 41, the respective LIDARs 42 and information processing of the detection results. The ECU 23 performs control of the other camera 41 and the respective radars 43, and information processing of the detection results. Two sets of the devices detecting the surrounding situation of the vehicle are included, so that reliability of the detection results can be enhanced, and different kinds of detection units such as the camera, LIDAR and the radar are included, so that analysis of the surrounding environment (also referred to as the surrounding state) of the vehicle can be performed multilaterally.

An ECU 24 performs control of a gyro sensor 5, a GPS sensor 24b, and a communication device 24c and information processing of the detection results or communication results. The gyro sensor 5 detects rotational movement of the vehicle 1. A course of the vehicle 1 can be determined by a detection result of the gyro sensor 5, a wheel speed and the like. The GPS sensor 24b detects a present position of the vehicle 1. The communication device 24c performs wireless communication with a server that provides map information and traffic information, and acquires these kinds of information. The ECU 24 is accessible to the database 24a of the map information constructed in the memory device, and the ECU 24 performs route search to a destination from a present location, and the like.

An ECU 25 includes a communication device 25a for communication between vehicles. The communication device 25a performs wireless communication with other surrounding vehicles, and exchanges information with the vehicles.

An ECU 26 controls a power plant (that is, a traveling driving force output device) 6. The power plant 6 is a mechanism that outputs a driving force that rotates driving wheels of the vehicle 1, and includes, for example, an engine and a transmission. The ECU 26 controls output of the engine in response to a driving operation (an accelerator operation or accelerating operation) of the driver that is detected by an operation detecting sensor (that is, an accelerator opening degree sensor) 7a provided at an accelerator pedal 7A, for example, and switches a gear ratio of the transmission based on the information on a vehicle speed or the like detected by a vehicle speed sensor 7c. When the driving state of the vehicle 1 is automated driving, the ECU 26 automatedly controls the power plant 6 in response to an instruction from the ECU 20, and controls acceleration and deceleration of the vehicle 1. Accelerations in respective directions and an angular acceleration around an angular axis that are detected by the gyro sensor 5, a vehicle speed detected by the vehicle speed sensor 7c and the like are information indicating a traveling state of the vehicle, and these sensors are also collectively referred to as a traveling state monitoring unit. Further, the operation detecting sensor 7a of the accelerator pedal 7A and an operation detecting sensor (that is, a brake stepping amount sensor) 7b of a brake pedal 7B that will be described later may be included in the traveling state monitoring unit, but in the present example, these sensors are referred to as an operating state detecting unit with detection units not illustrated that detect operating states to other devices.

An ECU 27 controls lighting devices (a headlight, a tail light and the like) including a direction indicator 8. In the case of the example in FIG. 1, the direction indicator 8 is provided at the front portion, door mirrors and the rear portion of the vehicle 1.

An ECU 28 performs control of an input/output device 9. The input/output device 9 outputs information to the driver and receives input of information from the driver. An audio output device 91 informs the driver of information by a sound. A display device 92 informs the driver of information by display of an image. The display device 92 is disposed on, for example, a driver's seat front surface and configures an instrument panel or the like. Here, sound and display are illustrated, but the driver may be informed of information by vibration or light. Further, the driver may be informed of information by combining a plurality of things of a sound, display, vibration and light. Further, the combination may be made different, or an informing mode may be made different according to a control state (for example, a degree of urgency) of the information to be informed. An input device 93 is a switch group that is disposed in a position where the driver can operate the input device 93 to perform an instruction to the vehicle 1, and may include an audio input device. The input device 93 also includes a cancel switch for manually lowering the level of the automated driving control state. Further, the input device 93 also includes an automated driving switching switch for switching driving to automated driving from manual driving. The driver who desires to lower the level of the automated driving control state can lower the level by operating the cancel switch. In the present embodiment, the level can be lowered by the same cancel switch, regardless of the level of the automated driving control state.

The ECU 29 controls the braking device 10 and a parking brake (not illustrated). The braking device 10 is, for example, a disk braking device, is provided at each of wheels of the vehicle 1, and decelerates or stops the vehicle 1 by applying resistance to rotation of the wheels. The ECU 29 controls an operation of the braking device 10 in response to a driving operation (braking operation) of the driver that is detected by the operation detecting sensor 7b provided at the brake pedal 7B, for example. When the driving state of the vehicle 1 is automated driving, the ECU 29 automatedly controls the braking device 10 in response to an instruction from the ECU 20, and controls deceleration and stoppage of the vehicle 1. The braking device 10 and the parking brake also can be operated to keep a stopping state of the vehicle 1. Further, when the transmission of the power plant 6 includes a parking lock mechanism, the parking lock mechanism also can be operated to keep the stopping state of the vehicle 1.

Vehicle Control System

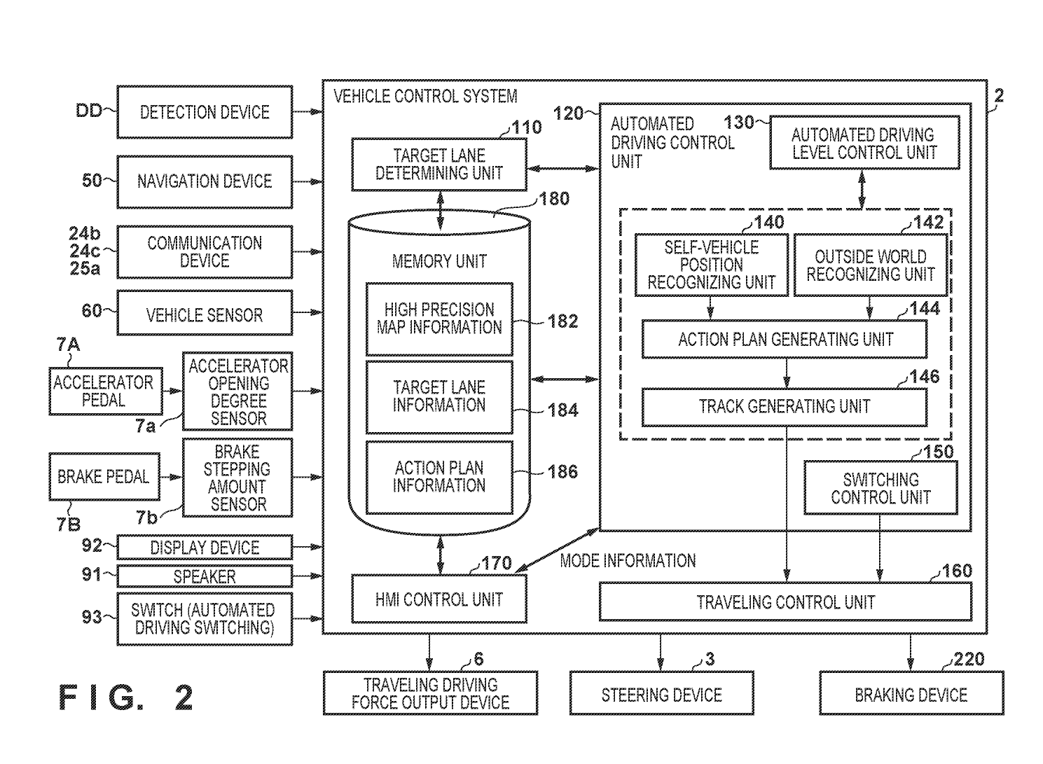

FIG. 2 illustrates a functional configuration of the control unit 2 in the present embodiment. The control unit 2 is also referred to as a vehicle control system, and realizes the respective functional blocks illustrated in FIG. 2 by the respective ECUs including the ECU 20 executing programs. In FIG. 2, the vehicle 1 is loaded with a detection device DD including the cameras 41, the LIDARs 42, the radars 43 and the like, a navigation device 50, the communication devices 24b, 24c and 25a, a vehicle sensor 60 including the gyro sensor 5, the steering wheel grasping sensor, the driver state detecting camera 41a and the like, the accelerator pedal 7A, the accelerator opening degree sensor 7a, the brake pedal 7B, the brake stepping amount sensor 7b, the display device 92, the speaker 91, the switch 93 including an automated driving switching switch, the vehicle control system 2, the traveling driving force output device 6, the steering device 3 and a braking device 220. These devices and equipment are connected to one another by a multiplex communication line such as CAN (Controller Area Network) communication line and a serial communication line, a wireless communication network and the like.

The navigation device 50 has a GNSS (Global Navigation Satellite System) receiver and map information (navigation map), a touch panel type display device that functions as a user interface, a speaker, a microphone and the like. The navigation device 50 identifies a position of the self-vehicle 1 by the GNSS receiver, and derives a route to a destination designated by the user from the position. The route which is derived by the navigation device 50 is provided to a target lane determining unit 110 of the vehicle control system 2. Note that a configuration for identifying the position of the self-vehicle 1 may be provided independently from the navigation device 50.

The communication devices 24b, 24c and 25a perform wireless communication using, for example, a cellular network, a Wi-Fi network, Bluetooth (registered trade mark), DSRC (Dedicated Short Range Communication) and the like.

The vehicle sensor 60 includes a vehicle speed sensor that detects a vehicle speed, an acceleration sensor that detects acceleration, a yaw rate sensor that detects an angular speed around a vertical axis, an azimuth sensor that detects an orientation of the self-vehicle 1 and the like. All or some of these sensors are realized by the gyro sensor 5. Further, the steering wheel grasping sensor 210I and the driver state detecting camera 41a may be included in the vehicle sensor 60.

The accelerator pedal 7A is an operator for accepting an acceleration instruction (or a deceleration instruction by a returning operation) by the driver. The accelerator opening degree sensor 7a detects a stepping amount on the accelerator pedal 7A, and outputs an accelerator opening degree signal indicating the stepping amount to the vehicle control system 2. Note that the accelerator opening degree sensor 7a may directly outputs the accelerator opening degree signal to the traveling driving force output device 6, the steering device 3 or the braking device 220, instead of outputting the accelerator opening degree signal to the vehicle control system 2. The same thing applies to the configurations of other driving operation systems that will be described as follows.

The brake pedal 7B is an operator for accepting a deceleration instruction by the driver. The brake stepping amount sensor 7b detects the stepping amount (or a stepping force) on the brake pedal 7B, and outputs a brake signal indicating a detection result to the vehicle control system 2.

The display device 92 is an LCD (Liquid Crystal Display), an organic EL (Electroluminescence) display device and the like that are attached to respective portions on the instrument panel, arbitrary spots facing to a front passenger seat, a rear seat and the like. Further, the display device 92 may be a HUD (Head Up Display) that projects an image on a front windshield, and other windows. The speaker 91 outputs a sound.

The traveling driving force output device 6 outputs a traveling driving force (torque) for a vehicle to travel, to the driving wheels. The traveling driving force output device 6 include, for example, the engine, the transmission and the engine ECU (Electronic Control Unit) that controls the engine. Note that the traveling driving force output device 6 may be an electric motor, or a hybrid engine in which an internal combustion engine and an electric motor are combined.

The braking device 220 is an electric servo braking device including, for example, a brake caliper, a cylinder that transmits hydraulic pressure to the brake caliper, an electric motor that causes the cylinder to generate hydraulic pressure, and a braking control unit. The braking control unit of the electric servo braking device controls the electric motor in accordance with information that is input from the traveling control unit 160 so that braking torque corresponding to the braking operation is output to the respective wheels. Further, the braking device 220 may include regenerative brake by the motor for traveling that can be included in the traveling driving force output device 6.

Steering Device

Next, the steering device 3 will be described. The steering device 3 includes, for example, the steering ECU 21 and an electric motor. The electric motor changes a direction of turning wheels by causing a force to act on a rack and pinion mechanism, for example. The steering ECU 21 drives the electric motor in accordance with information input from the vehicle control system 2 or information on the input steering wheel steering angle or steering torque, and changes the direction of the turning wheels.

FIG. 3 is a diagram illustrating a configuration example of the steering device 3 according to the present embodiment. The steering device 3 may include a steering wheel (also referred to as a handle) 31, a steering shaft 210B, a steering wheel steering angle sensor 210C, a steering wheel torque sensor 210D, a reaction force motor 210E, an assist motor 210F, a turning mechanism 210G, a turning angle sensor 210H, the steering wheel grasping sensor 210I, a turning wheel 210J and a steering ECU 21, but is not limited thereto. Further, the steering ECU 21 has a steering reaction force setting unit 210M, and a memory unit 210N respectively.

The steering wheel 31 is an example of an operation device that accepts a steering instruction by the driver. A steering input, that is, a steering operation that is given to the steering wheel 31 is transmitted to the steering shaft 210B. To the steering shaft 210B, the steering wheel steering angle sensor 210C, and the steering torque sensor 210D are attached. The steering wheel steering angle sensor 210C detects an angle at which the steering wheel 31 is operated and outputs the angle to the steering ECU 21. The steering torque sensor 210D detects torque (steering torque) that acts on the steering shaft 210B, and outputs the torque to the steering ECU 21. That is, the steering torque is torque that acts on the steering shaft 210B by the driver turning the steering wheel 31. The reaction force motor 210E outputs a steering reaction force to the steering wheel 31 by outputting torque to the steering shaft 210B by control of the steering ECU 21. That is, the reaction force motor 210E applies a predetermined steering reaction force for keeping steering (also referred to as system steering) in the automated driving to the steering shaft 210B, in the respective automated driving control states, by control of the steering ECU 21. The steering reaction force acts as the torque that resists to the steering operation of the driver. Accordingly, when the driver overrides the system steering, the driver has to give the torque that exceeds the steering reaction force which is generated in response to the steering input, to the steering shaft 210B.

The assist motor 210F assists in turning by outputting torque to the turning mechanism 210G by control of the steering ECU 21. Assist means not only assisting in the operation of the driver at the manual operation time, but also performing steering without an operation by the driver in response to control by the traveling control unit 160 at the dime of automated driving. The turning mechanism 210G is, for example, a rack and pinion mechanism. The turning angle sensor 210H detects an amount (for example, a rack stroke) indicating an angle (turning angle) at which the turning mechanism 210G performs drive control of the turning wheel 210J, and outputs the amount to the steering ECU 21. The steering shaft 210B and the turning mechanism 210G may be fixedly connected, may be cut off, or may be connected via a clutch mechanism or the like.

The steering wheel grasping sensor 210I is a pressure sensor that is provided at a predetermined position of a rim portion of the steering wheel 31, and measures pressure (hereinafter, also referred to as a grasping force) that is applied to the rim by grasping of the driver when the driver grasps the rim of the steering wheel 31. The steering wheel grasping sensor 210I outputs a measured grasping force to the steering ECU 21. The steering ECU 21 performs the above described various controls by cooperating with the vehicle control system 2.

The steering reaction force setting unit 210M refers to reaction force profile information 210P of the memory unit 210N in the steering ECU 21 with a difference between a steering angle (override steering angle) detected by the steering wheel steering angle sensor 210C and a system steering angle (for example, a steering angle determined by the traveling control unit 160) acquired from the vehicle control system 2 as an index value of steering input, in the automated driving control state. The reaction force profile information 210P is configured as a reaction force table showing a correspondence relationship between a steering angle difference between the override steering angle and the system steering angle, and the steering reaction force, for example. The steering reaction force setting unit 210M reads the steering reaction force corresponding to the above described steering angle difference from the reaction force table of the reaction force profile information 210P in the memory unit 210N. Further, based on a numeric value that is read by the steering reaction force setting unit 210M from the memory unit 210N, the steering ECU 21 performs drive control of the reaction force motor 210E so that the steering reaction force of the numeric value is applied to the steering shaft 210B. In the manual driving control state, the reaction force profile information set in advance for manual driving is prepared, and the reaction force is given in accordance with the reaction force profile information. When the steering shaft 210B is connected to the turning mechanism 210G as in the present example, a mechanical reaction force is transmitted to the steering wheel 31 from the turning wheel 210J, so that the reaction force does not have to be specially given. However, when a complete steer-by-wire in which the steering shaft is not mechanically connected to the turning mechanism 210G is realized, the reaction force may be generated in accordance with a reaction profile obtained by simulating the mechanical reaction force in order to give steering feeling to the driver. In the present example, the reaction force is given to have a characteristic corresponding to the automated driving control state of the automated driving. Note that setting of the reaction force will be described anew with reference to FIGS. 3 to 5. Note that the steering angle and torque of steering and a speed or the like of steering are sometimes collectively referred to as a steering amount, and the steering amount determined by the traveling control unit 160 is sometimes referred to as a system steering amount.

By the aforementioned configuration, the steering reaction force which is applied to the steering wheel 31 is given in response to the difference between the steering angle by the override operation of the steering wheel 31 of the driver in the automated driving control state and the system steering angle, and the automated driving control state. At this time, as the level of the automated driving control state is higher, the reaction force is made larger. In this way, if the level of the automated driving control state is high, override can be made difficult, and if the level of the automated driving control state is low, override can be made easy, in response to the level of the automated driving control state.

The steering reaction force setting unit 210M refers to the reaction force profile information 210P of the memory unit 210N each time the steering ECU 21 reads the system steering angle and the override steering angle in the automated driving control state. Subsequently, the steering reaction force setting unit 210M reads the steering reaction force corresponding to the difference between the system steering angle and the override steering angle which are read, and the level of the automated driving control state, and outputs a control signal for giving the steering reaction force to the reaction force motor 210E.

Vehicle Control System (Continued)

Returning to FIG. 2, the vehicle control system 2 includes, for example, the target lane determining unit 110, an automated driving control unit 120, the traveling control unit 160, a HMI (human machine interface) control unit 170 and a memory unit 180. The automated driving control unit 120 includes, for example, an automated driving level control unit 130, a self-vehicle position recognizing unit 140, an outside world recognizing unit 142, an action plan generating unit 144, a track generating unit 146, and a switching control unit 150. The target lane determining unit 110, the respective units of the automated driving control unit 120, and the traveling control unit 160, and a part or whole of the HMI control unit 170 are realized by the processor executing a program (software). Further, some or all of these units may be realized by hardware such as LSI (Large Scale Integration) and ASIC (Application Specific Integrated Circuit), or may be realized by combination of the software and the hardware.

In the memory unit 180, for example, information such as high precision map information 182 including information on a center of a lane, information on a boundary of the lane or the like, target lane information 184, and action plan information 186 is stored. The target lane determining unit 110 divides a route provided from the navigation device 50 into a plurality of blocks (for example, divides every 100 [m] concerning a vehicle traveling direction), and determines a target lane for each block by referring to the high precision map information 182. The target lane determining unit 110 performs determination such as determination to travel on how-manieth lane from left, for example. The target lane determining unit 110 determines a target lane so that the self-vehicle 1 can travel on a reasonable traveling route for advancing to a branched spot when the branched spot, a merging spot and the like exist in the route, for example. The target lane determined by the target lane determining unit 110 is stored in the memory unit 180 as the target lane information 184.

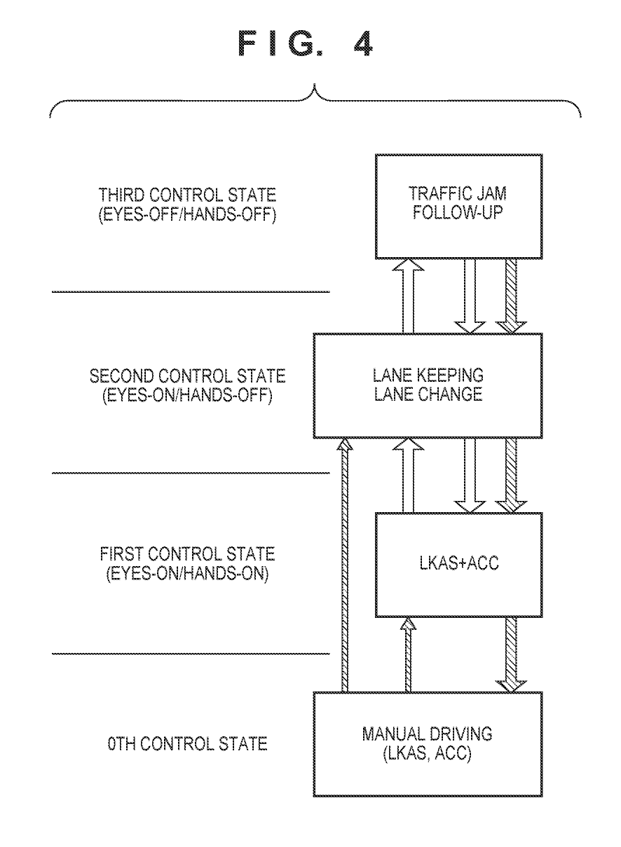

The automated driving level control unit 130 determines the automated driving control state (also referred to as the automation level by paying attention to automation rates of the respective states) which is carried out by the automated driving control unit 120. The automated driving control state in the present embodiment includes the following control states. Note that the following control states are only examples, and the number of control states of the automated driving may be arbitrarily determined. FIG. 4 illustrates a transition diagram of the automated driving control state.

Transition of Automated Driving Control State

As illustrated in FIG. 4, the present embodiment has the 0^{th} control state to the third control state as the automated driving control states, and the automation rate becomes higher in this order. Note that in FIG. 4, arrows show transition of the state. Of the arrows, white arrows show transition of the automated driving control state which is performed by the automated driving realized by the vehicle control system 2 (in particular, the ECU 20) executing a program, for example, that is, performed mainly by the vehicle 1. On the other hand, black arrows show transition of the automated driving control state that is performed with the operation of the driver as a trigger. Here, the respective automated driving control states will be described over again.

The 0^{th} control state is the level of the manual driving, in which the driving support functions such as LKAS (lane keeping function) and ACC (adaptive cruising control function) can be used, but the automated driving control state does not change unless the driver instructs to switch to the automated driving explicitly. When the driver explicitly instructs automated driving by the switch operation, for example, in the 0^{th} control state, the automated driving control state transitions to the first control state or the second control state in response to the external environment, the vehicle information and the like at that time. The control unit 2 determines to which control state to transition by referring to the external environment information, the traveling state information and the like.

The first control state is at a level of the lowest automated driving control state of the automated driving (the automation rate is the lowest). For example, when the present location cannot be recognized when the automated driving is instructed, or in the environment (for example, an ordinary road or the like) where the second control state cannot be applied even though the present location can be recognized, the automated driving is started in the first control state. The automation function realized in the first control state includes LKAS, ACC and the like. Further, when the automated driving control state is to transition to the first control state, the automated driving control state transitions to the first control state when the driver state detecting unit detects that the driver monitors the outside, and grasps the steering wheel, and the conditions are satisfied. Further, monitoring by the driver may be also performed continuously while the automated driving control state remains in the first control state. When the automated driving control state is caused to transition to a high level from a low level, the state of the driver does not have to be set as the condition of transition, because the task imposed on the driver does not change or decreases.

The second control state is the automated driving control state at a level just above the first control state. For example, when keeping the automated driving is accepted in the 0^{th} control state, and the external environment at that time is a predetermined environment (during traveling on a highway or the like, for example), the automated driving control state transitions to the second control state. Alternatively, when it is detected that the external environment is the aforementioned predetermined environment during the automated driving in the first control state, the automated driving control state automatically transitions to the second control state. Determination of the external environment may be performed by referring to the present position and the map information, besides a monitoring result of the surroundings monitoring unit including cameras and the like, for example. In the second control state, the functions of performing lane change and the like in response to the target such as vehicles in the surroundings are also provided in addition to lane keeping. When the condition of keeping the second control state is lost, the automation level of the vehicle 1 is changed to the first control state by the control unit 2. In the second control state, the driver does not have to hold the steering wheel (this is referred to as hands-off), only monitoring the surroundings is imposed on the driver. Therefore, in the second control state, the driver state detecting camera 41a monitors whether the driver monitors the outside, and if the driver fails to monitor the outside, a warning, for example, is issued.

The third control state is the automated driving control state of the level just above the second control state. The automated driving control state can transition to the third control state from the second control state, but does not transition from the 0^{th} control state or the first control state by skipping the second control state. Further, transition to the third control state is not performed with the instruction of the driver as the trigger, but the transition is performed when it is determined that the fixed condition is satisfied by automated control by the control unit 2. For example, when the vehicle encounters a traffic jam and is brought into a state in which the vehicle tracks the preceding vehicle at low speed, during the automated driving in the second control state, the automated driving control state is switched to the third control state from the second control state. Determination in this case is performed based on the output by the surroundings monitoring unit such as cameras, the vehicle speed and the like. When the condition of the second control state is satisfied, for example, when the vehicle is traveling on a highway, transition of the automated driving control state is performed between the second control state and the third control state. In the third control state, the driver does not have to grasp the steering wheel or does not have to monitor surroundings, so that the state of the driver does not have to be monitored while the automated driving control state is remaining in the third control state.

The automated driving level control unit 130 determines the control state of the automated driving based on the operation of the driver to the respective configurations of the above described driving operation system, the event determined by the action plan generating unit 144, the traveling mode determined by the track generating unit 146 and the like, and causes the control state to transition to the control state determined in accordance with the white arrows illustrated in FIG. 4. The HMI control unit 170 is notified of the automated driving control state. In any of the control states, it is possible to overwrite (override) the automated driving by the manual driving, by the operation to the configuration of the driving operation system in the respective configurations of the driving operation system. In the above described explanation, the steering reaction force setting unit 210M is explained as determining the reaction force based on the steering angle difference and the automated driving control state, but the automated driving level control unit 130 may be configured to set the reaction force table corresponding to the change of the control state. In this way, the steering reaction force setting unit 210M can determine the steering reaction force without considering the automated driving control state.

The self-vehicle position recognizing unit 140 of the automated driving control unit 120 recognizes the lane (traveling lane) where the self-vehicle 1 is traveling, and a relative position of the self-vehicle 1 to the traveling lane, based on the high precision map information 182 stored in the memory unit 180, and information input from the finder 20, the radar 30, the camera 40, the navigation device 50 or the vehicle sensor 60.

The self-vehicle position recognizing unit 140 recognizes the traveling lane by comparing a pattern (for example, arrangement of a solid line and a broken line) of the road division line recognized from the high precision map information 182, and the pattern of the road division line around the self-vehicle 1 that is recognized from the image which is picked up by the camera 40. In the recognition, the position of the self-vehicle 1 acquired from the navigation device 50 and the processing result by INS may be added. The traveling control unit 160 controls the traveling driving force output device 6, the steering device 3 and the braking device 220 so that the self-vehicle 1 passes through the track generated by the track generating unit 146 according to a scheduled time. The HMI control unit 170 causes the display device 92 to display video and an image, and causes the speaker 91 to output a sound. The traveling control unit 160 determines the steering wheel steering angle (system steering angle) for automated driving along the action plan information 186, and inputs the steering wheel steering angle to the steering device 3 to cause the steering device 3 to perform steering control.

The outside world recognizing unit 142 recognizes the position of the target such as surrounding vehicles, and the states of the speed, acceleration and the like based on the information which is input from the cameras 41, LIDARs 42, the radars 43 and the like. Further, the outside world recognizing unit 142 may recognize positions of guardrails, utility poles, parked vehicles, pedestrians and other matters in addition to the surrounding vehicles.

The action plan generating unit 144 sets a starting point of the automated driving and/or a destination of the automated driving. The starting point of the automated driving may be the present position of the self-vehicle 1, or may be the point where an operation of instructing the automated driving is performed. The action plan generating unit 144 generates the action plan in a section between the starting point and the destination of the automated driving. Note that the action plan generating unit 144 may generate an action plan with respect to an arbitrary section without being limited thereto.

The action plan is configured by a plurality of events that are sequentially executed, for example. The events include, for example, a deceleration event of decelerating the self-vehicle 1, an acceleration event of accelerating the self-vehicle 1, a lane keeping event of causing the self-vehicle 1 to travel not to deviate from the traveling lane, a lane changing event of changing a traveling lane, a passing event of causing the self-vehicle 1 to pass a preceding vehicle, a branch event of changing to a desired lane in a branch point, or causing the self-vehicle 1 to travel not to deviate from the present traveling lane, a merging event of accelerating or decelerating the self-vehicle 1 in a merging lane for merging with a main lane and causing the self-vehicle 1 to change the traveling lane, a handover event of shifting the driving control state to the manual driving control state from the automated driving control state at a scheduled end point of the automated driving, and the like. The action plan generating unit 144 sets the lane changing event, the branch event or the merging event in the spot where the target lane determined by the target lane determining unit 110 is switched. Information indicating the action plan generated by the action plan generating unit 144 is stored in the memory unit 180 as the action plan information 186.

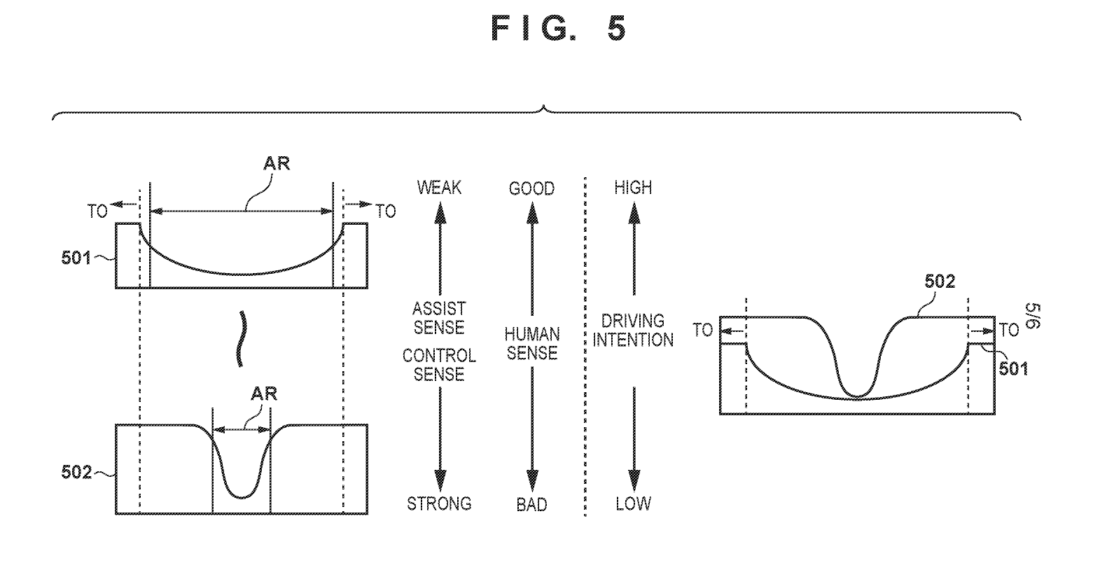

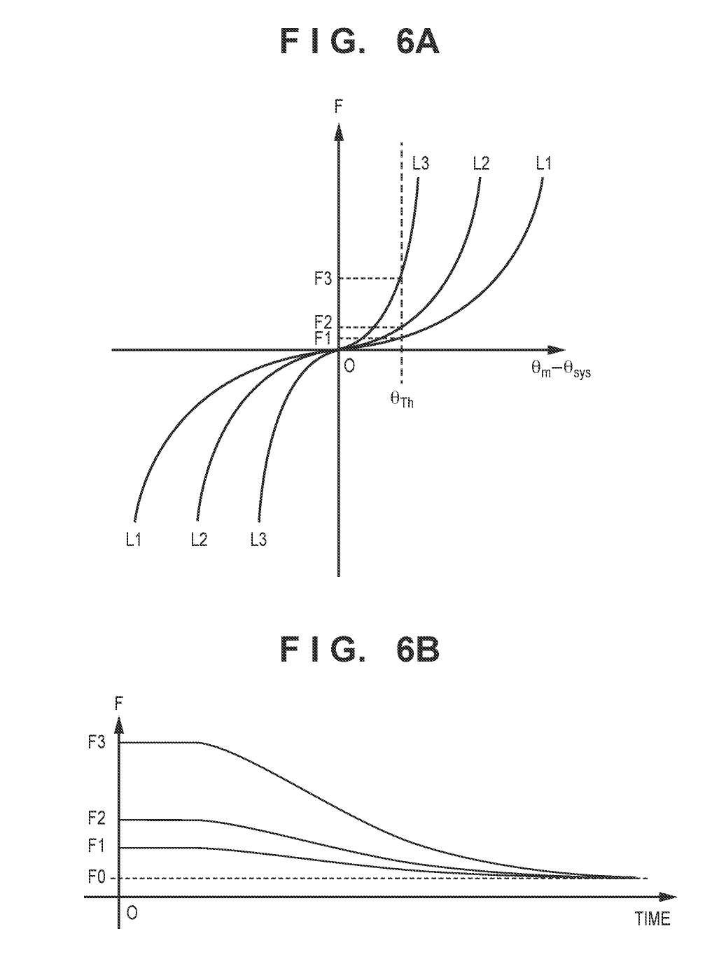

The switching control unit 150 switches the automated driving control state and the manual driving control state to each other based on the signal that is input from the automated driving switching switch 93. Further, the switching control unit 150 switches the control state to the manual driving (the 0^{Th} control state) from the automated driving (the third to first control states) based on the operation of the brake pedal 7B. In the present example, when the brake operation is performed, the switching control unit 150 switches the driving control state to the manual driving control state from the automated driving control state after a grace time period corresponding to the automation control state at that time and a warning. Further, with respect to the steering operation and the accelerator operation, override control is performed in accordance with the manual operation while the automated driving is kept. Here, for example, when the steering operation amount exceeds a predetermined override threshold, traveling control which is as if the driving were switched to the manual driving is realized, by override control. Next, override control will be described with reference to FIGS. 5 and 6.

Override Control

Next, the override control according to the present embodiment, in particular, override control of the steering will be described. Before that, a characteristic of the steering control in the automated driving will be described with reference to FIG. 5. A left side in FIG. 5 is a diagram explaining a route keeping characteristic by automated driving, an upper control image 501 illustrates a control state where the level of the automated driving control state is low, and hands-on is specially required, and a lower control image 502 illustrates a case where the level of the automated driving control state is high and hands-off is applicable. The respective control images illustrate the characteristics to keep the route as sectional shapes of the road, for example. The control images also can be read as illustrating the strength of the control to keep a lane center with respect to a height direction. These diagrams do not illustrate sectional shapes of real roads as a matter of course, but are image diagrams for explaining the characteristics by modeling the characteristics after the shapes. Further, though omitted in FIG. 5, there may be an intermediate control state. A center in FIG. 5 is a diagram illustrating senses of the driver corresponding to the levels of the automated driving control state. Further, a right side in FIG. 5 illustrates the control images 501 and 502 by overlapping the control images 501 and 502, and shows that a magnitude of the steering reaction force is changed according to the driving control state.

The control image 501 in FIG. 5 illustrates a characteristic of steering control in the automated driving in which the level of the automated driving control state is low. TO shows a region where the vehicle does not travel, and an inside thereof is an inside of the lane, and the vehicle can travel inside the lane. AR shows a range in which the vehicle travels by automated driving. An inclination of the characteristic curve shows that control is performed to take a course to an inclined side. That is, in the control image 501, weak control to return to a center works as long as the vehicle is within the lane. Further, when the vehicle is traveling by the automated driving in the range AR, the steering reaction force works to the steering wheel operation by the driver, the manual steering wheel operation is made difficult, and control by the automated driving is kept as much as possible. However, when the vehicle deviates from the range AR, the steering reaction force is reduced, manual driving is prioritized, that is, override is easily performed (or enabled). In this way, when the level of the automated driving control state is low, control to return to the lane center is slow inside the lane even in automated driving, and control to return to the center is weak even when the vehicle shifts to a left or a right more or less, for example. However, when the vehicle approaches a shoulder of the road, control to return to the lane center is abruptly started, and deviation from the lane is prevented. Further, as for override, when the manual operation is performed to exceed the range AR, the steering reaction force is reduced, and a manual operation becomes easy. That is, in the driving control state of a low level, the load on the driver is originally high, override is easily allowed even when override is performed during automated driving, and override is accepted as long as the vehicle is kept in the lane.

When the level of the automated driving control state becomes high on the other hand, the characteristic of keeping the lane center is strong as in the control image 502 at the lower left in FIG. 5. In this case, the range where the vehicle travels by automated driving is narrow, and when the vehicle deviates from the narrow range even slightly, the control to return to the center works strongly, so that the vehicle is returned to the center. Under the control like this, it is desirable to avoid deviation from the lane center by override as much as possible, so that override is made difficult to be allowed by increasing the steering reaction force, and the illustrated characteristic thereby is desirably kept. In the control image 502, the range AR is narrower as compared with the control image 501, and when the range AR is exceeded, the control state shifts to override by making the reaction force weak. Further, the reaction force until the range AR is exceeded is larger than the reaction force in the control image 501, and an explicit intention is required for manual operation.

Here, display in the center of FIG. 5 shows the senses of the driver corresponding to the automated driving control states. That is, as the level of the automated driving control state is higher, the sense of assist and the sense of control become stronger, and on the other hand, a human sense, for example, the sense of driving by the driver becomes better as the level of the automated driving control state is lower. Further, the intention of driving at the most right side does not shows the intention corresponding to the level of the automated driving control state, but shows that as the intention of driving is stronger (higher), it is more desirable to allow override by lowering the level of the automated driving control state. In the present example, the intention of driving is estimated by torque of the steering shaft 210B which is generated by the driver turning the steering wheel 31, and the rotation angle. That is, when the steering wheel 31 is rotated at a fixed angle against the steering reaction force corresponding to the automated driving control state, override is allowed, and the manual operation becomes easy. As a matter of course, estimation may be made by using other index values such as grasping strength of the steering wheel, and the rotational speed of the steering wheel. The right side in FIG. 5 illustrates the control images 501 and 502 by overlapping the control images 501 and 502, and here, a vertical direction shows the magnitude of the steering reaction force, for example. That is, it is shown that the steering reaction force in the automated driving control state in which the automation rate is high is larger than the steering reaction force in the automated driving control state in which the automation rate is low.

A characteristic of the steering reaction force for realizing the control like this is illustrated in FIGS. 6A and 6B. In FIG. 6A, an ordinate represents the steering reaction force, and an abscissa represents a difference (θm−θsys) between a system steering angle θsys and a manual steering angle θm by a manual operation. Curves L1, L2 and L3 show characteristic curves of the steering reaction forces in the first, second and third control states respectively. Further, θTh represents an override threshold value. When the third control state is taken as an example, when the driver performs a steering operation when the system steering angle is θsys, the steering reaction force setting unit 210M increases the steering reaction force along the curve L3, and the reaction force motor 210E increases the reaction force in accordance with the curve L3, in response to increase in the angle difference θm−θsys. The curve L3 may be a discrete value if only the curve L3 has the characteristic as illustrated. The driver has to perform a steering operation against the steering reaction force. When the angle difference θm−θsys exceeds the override threshold θTh, the override operation becomes possible at that time, and the steering reaction force setting unit 210M sets the reaction force at the manual operation time. However, a transitional characteristic may be given here. FIG. 6B illustrates an example of the transitional characteristic. The steering reaction force in the override threshold θTh in the third control state is set as F3. The steering reaction force setting unit 210M does not abruptly change the steering reaction force F3 even when the operation shifts to an override operation, but gradually changes the steering reaction force F3 to the reaction force F0 at the time of manual operation by taking a fixed time period. That is, the steering reaction force is the reaction force corresponding to the angle difference in accordance with the characteristic in FIG. 6A until the angle difference θm−θsys reaches the threshold θTh, and when the angle difference θm−θsys exceeds the threshold θTh, the steering reaction force is controlled to be the reaction force corresponding to a lapse of time to follow the characteristic in FIG. 6B. The steering reaction force at the manual operation time becomes zero in a state where the steering is neutral, and is in an opposite direction to the direction of the steering operation, so that the reaction force at the manual operation time becomes −F0 depending on the steering direction. This similarly applies to the other automated driving control states though the values are different. Further, FIG. 6A illustrates the case where the angle difference θm−θsys is positive, but in the case of a negative value, similar control is performed with −θTh as the threshold.

In this way, in the reaction force profile information 210P, a table in which the angle difference (θm−θsys) between the system steering angle θsys and the manual steering angle θm and the steering reaction force are associated with each other for each of the automated driving control states as illustrated in FIG. 6A, and a table of the transitional characteristic at the time of the angle difference (θm−θsys) exceeding the override threshold θTh illustrated in FIG. 6B are stored. Until the angle difference (θm−θsys) reaches the override threshold, the steering reaction force setting unit 210M sets a corresponding steering reaction force with the angle difference as an input. In this way, when the level of the automated driving control state is high, a larger steering reaction force is given, and when the level of the automated driving control state is low, a smaller steering reaction force is given. The angle (θm−θsys) of the steering wheel operation against the steering reaction force is regarded as an index value of the driving intention of the driver, and when the index value reaches the threshold, the operation shifts to the override operation in which driving with the intention of the driver being reflected can be easily performed.

By the configuration and control as above, according to the vehicle control device of the present embodiment, even in the vehicle which is traveling by automated driving, override action by the driver becomes possible. Further, at the time of start of the override operation, by giving the steering reaction force corresponding to the automated driving control state to steering, the route by the automated driving is easily kept as the level of the automated driving control state is higher. Conversely, as the level of the automated driving control state is lower, it becomes easier to override the automated driving. Further, in order to override the automated driving, it is necessary to be against the steering reaction force, and at the time of the switching to the override operation, the driving intention of the driver can be reflected. That is, in the present embodiment, override is difficult unless the driving intention is high.

### Other Embodiments

In the above described embodiment, the override threshold θTh is fixed irrespective of the automated driving control state. However, the override threshold may be changed in response to the automated driving control state. For example, the respective override thresholds θTh1, θTh2 and θTh3 of the first, second and third control states may be set to satisfy |θTh1|<|θTh2|<|θTh3|. However, a sign of the angle difference (θm−θsys) and a sign of each of the thresholds are the same. In this way, the override operation in the case of the level of the automated driving control state being low is made easier, and conversely the override operation in the case of the level of the automated driving control state being high can be made more difficult to perform. Thereby, in the automated driving control state at a higher level (that is, the automated driving control state with the high automation rate), stable driving that hardly deviates from control by the automated driving is enabled, and on the other hand, in the automated driving control state at a low level (that is, the low automation rate), it is easy to deviate from control by the automated driving, and the manual operation becomes easy.

Alternatively, the driver state is monitored by the steering wheel grasping sensor, the driver state detecting camera 41a and the like, and from the state of the driver obtained by monitoring, the override threshold may be determined, or whether or not to permit the override operation may be determined. That is, in the above described example, a degree of steering input by the driver is measured with the difference between the system steering angle and the manual steering angle (also referred to as the correction steering angle) as the index value, and the degree of the steering input is regarded as the index value indicating the degree of the driving intention and desire of the driver. However, in the present modified example, the state of the driver is detected more directly, and the detected state is converted into the index value indicating the degree of the driving intention and desire of the driver. When the index value is high, the driving intention of the driver is determined as high, and the override operation is permitted. For example, when it is determined that the driver is performing steering input (even when the aforementioned angle difference is less than the override threshold), the driver state is determined. As for the driver state, it is determined whether the driver carefully watches the outside from the image captured by the driver state monitoring camera 41a, and it is determined whether the driver is in a state grasping the steering wheel from the steering wheel grasping sensor. When the state corresponds to both the states, the override operation is permitted at that point of time, and the steering reaction force is converged to the reaction force at the manual driving time as in FIG. 6B, for example. Alternatively, when the state corresponds to both the states, the override threshold may be set to be lower again. Alternatively, when it is detected by the accelerator opening degree sensor 7a that the accelerator operation is further performed, the override operation may be permitted at that point of time, or a lower threshold may be set again. Alternatively, satisfying either of the aforementioned states may be set as a condition for override or a condition for making the override threshold low. In any case, in the present modified example, the state of the driver is directly detected, or another operation by the driver is further detected, and the override operation is configured to be permitted based thereon. Thereby, the driving intention of the driver is estimated from not only the steering wheel operation but also the other elements, and override can be performed based thereon.

Further, the steering device 3 also includes the torque sensor 210D, so that torque of the steering by the manual operation may be made the index value instead of the steering angle. That is, when the torque exceeds a threshold, the override operation is permitted. A large/small relationship or the like of the threshold of each automated driving control state may be similar to that in the aforementioned embodiment.

### Summary of the Embodiment

The present embodiment described above is summarized as follows.

(1) According to a first aspect of the present invention, the present invention is a vehicle control device that carries out driving support or automated driving of a self-vehicle, characterized by having a steering controller that performs steering control on a manual operation by a driver or an automated operation by the vehicle control device, the steering controller,

being able to accept a steering input by a manual operation by the driver in addition to a system steering amount by the vehicle control device, while steering control by the vehicle control device is performed,

returning a predetermined reaction force to the manual operation upon accepting the steering input, and

making the reaction force to the manual operation larger in a case where traveling is performed in a second state where steering wheel grasping is unrequired, as compared with a case where traveling is performed in a first state where steering wheel gasping is required.

According to the configuration, when the level of the automated driving control state is low, override is easily performed, and when the level is high, stability of automated driving can be enhanced by increasing the steering reaction force.

(2) According to a second aspect of the present invention, the present invention is a vehicle control device that carries out driving support or automated driving of a self-vehicle, characterized by

having a steering controller that performs steering control on a manual operation by a driver or an automated operation by the vehicle control device, the steering controller,

being able to accept a steering input by a manual operation by the driver in addition to a system steering amount by the vehicle control device, while steering control by the vehicle control device is performed,

returning a predetermined reaction force to the manual operation upon accepting the steering input, and

making the reaction force to the manual operation larger in a case where traveling is performed in a second state where surroundings monitoring is unrequired, as compared with a case where traveling is performed in a first state where surroundings monitoring is required.

According to the configuration, when the level of the automated driving control state is low, override is easily performed, and when the level is high, stability of automated driving can be enhanced by increasing the steering reaction force.

(3) The vehicle control device according to (1) or (2), characterized in that

when an index value of the steering input exceeds a threshold, the reaction force is reduced.

According to the configuration, it is possible to set an override threshold adapted to an automated driving control state.

(4) The vehicle control device according to (3), characterized in that the index value is a difference between the system steering amount and a steering amount of the steering input by the driver.

According to the configuration, it is possible to perform control optimally by setting an override threshold from the difference between the steering amount of the manual operation and the system steering amount.

(5) The vehicle control device according to (3) or (4), characterized in that

the threshold in the second state is set to be larger than the threshold in the first state.
According to the configuration, override can be set to be difficult to accept when the level of the automated driving control state is high, and override can be set to be easy to accept when the level is low, and easiness of manual driving and stability of automated driving can be made compatible.

(6) The vehicle control device according to any one of (1) to (5), characterized in that

the threshold value is changed based on at least either a state of the driver, or an operation state of another operation performed by the driver.
According to the configuration, it becomes possible to determine override properly in response to an operation situation other than steering.

What is claimed is:

1. A vehicle control device that carries out driving support or automated driving of a self-vehicle, comprising:
a steering controller that performs steering control on a manual operation by a driver or an automated operation by the vehicle control device,
wherein the steering controller
accepts steering input by a manual operation by the driver in addition to a system steering amount by the vehicle control device while steering control by the vehicle control device is performed,
returns a predetermined reaction force to the manual operation upon accepting the steering input, and
makes the reaction force to the manual operation larger in a case where traveling is performed in a second state where steering wheel grasping is unrequired, as compared with a case where traveling is performed in a first state where steering wheel grasping is required.

2. The vehicle control device according to claim 1,
wherein when an index value of the steering input exceeds a threshold, the reaction force is reduced.

3. The vehicle control device according to claim 2,
wherein the index value is a difference between the system steering amount and a steering amount of the steering input by the driver.

4. The vehicle control device according to claim 2,
wherein the threshold in the second state is set to be larger than the threshold in the first state.

5. The vehicle control device according to claim 2,
wherein the threshold is changed based on at least either a state of the driver, or an operation state of another operation performed by the driver.

6. A vehicle control device that carries out driving support or automated driving of a self-vehicle, comprising:
a steering controller that performs steering control on a manual operation by a driver or an automated operation by the vehicle control device,
wherein the steering controller
can accept steering input by a manual operation by the driver in addition to a system steering amount by the vehicle control device while steering control by the vehicle control device is performed,
returns a predetermined reaction force to the manual operation upon accepting the steering input, and
makes the reaction force to the manual operation larger in a case where traveling is performed in a second state where surroundings monitoring is unrequired, as compared with a case where traveling is performed in a first state where surroundings monitoring is required.

7. The vehicle control device according to claim 6,
wherein when an index value of the steering input exceeds a threshold, the reaction force is reduced.

8. The vehicle control device according to claim 7,
wherein the index value is a difference between the system steering amount and a steering amount of the steering input by the driver.

9. The vehicle control device according to claim 7,
wherein the threshold in the second state is set to be larger than the threshold in the first state.

10. The vehicle control device according to claim 7,
wherein the threshold is changed based on at least either a state of the driver, or an operation state of another operation performed by the driver.
